(19) United States
(12) Patent Application Publication
(10) Pub. No.: US 2022/0119305 A1
(43) Pub. Date: Apr. 21, 2022

(54) Reflective Solar Control Coatings, and Articles Coated Thereof

(71) Applicant: Vitro Flat Glass LLC, Cheswick, PA (US)

(72) Inventors: Patrick Fisher, Pittsburgh, PA (US); Andrew V. Wagner, Pittsburgh, PA (US); Paul A. Medwick, Wexford, PA (US); Adam D. Polcyn, Pittsburgh, PA (US)

(21) Appl. No.: 17/506,184

(22) Filed: Oct. 20, 2021

Related U.S. Application Data
(60) Provisional application No. 63/094,510, filed on Oct. 21, 2020.

(51) Int. Cl. C03C 17/36

(52) U.S. Cl. CPC C03C 17/366; C03C 17/3649; C03C 2217/70; C03C 2217/28; C03C 2217/216

(57) ABSTRACT

A coated article includes a substrate and a coating that includes a first dielectric layer; a first metallic layer; a first primer layer; a second dielectric layer; a second metallic layer; a second primer layer; a third dielectric layer; a third metallic layer; a third primer layer; a fourth dielectric layer; and a protective layer; where the second metallic layer is a discontinuous metallic layer having an effective thickness in the range of from 5 Å to 20 Å; and where the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

### CROSS-REFERENCE TO RELATED APPLICATIONS

This application claims priority to U.S. Provisional Patent Application No. 63/094,510, filed Oct. 21, 2020, which is hereby incorporated by reference in its entirety.

### BACKGROUND OF THE INVENTION

### Field of the Invention

This invention relates generally to reflective coatings and articles coated with reflective coatings.

### Description of Related Art

Solar control coatings are known in the field of architectural transparencies. Solar control coatings block or filter selected ranges of electromagnetic radiation, such as in the solar infrared or solar ultraviolet ranges, to reduce the amount of solar energy entering the building. This reduction of solar energy transmittance helps reduce the load on the cooling units of the building. In some architectural applications, it may be desirable to have a reflective outer (or inner) surface so as to decrease visibility of one side of the transparency.

It would be desired to produce a coating with a specified reflectance (inner and/or outer) and/or transmittance to achieve desirable optical and aesthetic properties.

### SUMMARY OF THE INVENTION

In one aspect of the present invention, a coated article includes at least a first substrate having a first surface and a second surface opposite of the first surface. A coating may be positioned over one of the surfaces of the first substrate including the following layers. A first dielectric layer is positioned over at least a portion of the substrate. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer is positioned over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The coated article has an exterior reflectance of between 10% and 50%. The coated article has a neutral transmitted aesthetic CIELAB L*a*b* color value comprising an a* of greater than −4 and a b* in the range of from −4 to 4.

In another aspect of the present invention, a coated article includes at least a first substrate having a first surface and a second surface opposite of the first surface. A coating may be positioned over one of the surfaces of the first substrate including the following layers. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The third dielectric layer includes a first film comprising zinc oxide and having a thickness in the range of from 1 Å to 50 Å; and a second film over at least a portion of the first film of the third dielectric layer. The second film includes an oxide of a zinc alloy. The coated article may have an exterior reflectance of between 10% and 50%. The coated article has a neutral transmitted aesthetic CIELAB L*a*b* color value comprising an a* of greater than −4 and a b* in the range of from −4 to 4.

In another aspect of the present invention, a method of forming a coated article includes providing at least a first substrate having a first surface and a second surface opposite of the first surface. A coating is applied over at least a portion of one of the surfaces of the first substrate. A first dielectric layer is applied over at least a portion of the substrate. A first metallic layer is applied over at least a portion of the first dielectric layer. A first primer layer is applied over at least a portion of the first metallic layer. A second dielectric layer is applied over at least a portion of the first primer layer. A second metallic layer is applied over at least a portion of the second dielectric layer. A second primer layer is applied over at least a portion of the second metallic layer. A third dielectric layer is applied over at least a portion of the second primer layer. A third metallic layer is applied over at least a portion of the third dielectric layer. A third primer layer is applied over at least a portion of the third metallic layer. A fourth dielectric layer is applied over at least a portion of the third dielectric layer. A protective layer is applied over at least a portion of the fourth dielectric layer. The applying the second dielectric layer step includes applying a zinc stannate film. The second metallic layer is a discontinuous metallic layer having a thickness in the range of from 5 Å to 20 Å and is formed directly over at least a portion of the zinc stannate film of the second dielectric layer. The coated article may have an exterior reflectance of between 10% and 50%. The coated article has a neutral transmitted aesthetic CIELAB L*a*b* color value comprising an a* of greater than −4 and a b* in the range of from −4 to 4.

In another aspect of the present invention, a method of forming a coated article includes providing at least a first substrate having a first surface and a second surface opposite of the first surface. A coating is applied over at least a portion of one of the surfaces of the first substrate. A first metallic layer is applied over at least a portion of the first dielectric layer. A first primer layer is applied over at least a portion of the first metallic layer. A second dielectric layer is applied over at least a portion of the first primer layer. A second metallic layer is applied over at least a portion of the second dielectric layer. A second primer layer is applied over at least a portion of the second metallic layer. A third dielectric layer is applied over at least a portion of the second primer layer. A third metallic layer is applied over at least a portion of the third dielectric layer. A third primer layer is applied over at least a portion of the third metallic layer. A fourth dielectric layer is applied over at least a portion of the third dielectric layer. A protective layer is applied over at least a portion of the fourth dielectric layer. The applying the second dielectric layer step includes applying a zinc stannate film. The second metallic layer is a discontinuous metallic layer having a thickness in the range of from 5 Å to 20 Å and which is formed directly over at least a portion of the zinc stannate film of the second dielectric layer. The applying a third dielectric layer step includes applying the first film including zinc oxide and having a thickness in the range of from 1 Å to 50 Å; and applying a second film over at least a portion of the first film of the third dielectric layer, the second film containing an oxide of a zinc alloy. The coated article may have an exterior reflectance of between 10% and 50%. The coated article has a neutral transmitted aesthetic CIELAB L*a*b* color value comprising an a* of greater than −4 and a b* in the range of from −4 to 4.

In another aspect of the present invention, a coated article includes at least a first substrate having a first surface and a second surface opposite of the first surface. A coating may be positioned over one of the surfaces of the first substrate including the following layers. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer is positioned over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The coated article may have a visible light transmittance in the range of from 40% to 60%. The coated article has a neutral transmitted aesthetic CIELAB L*a*b* color value comprising an a* of greater than −4 and a b* in the range of from −4 to 4.

In another aspect of the present invention, a coated article includes at least a first substrate having a first surface and a second surface opposite of the first surface. A coating may be positioned over one of the surfaces of the first substrate including the following layers. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer is positioned over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The third dielectric layer includes the first film comprising zinc oxide and having a thickness in the range of from 1 Å to 50 Å, and a second film over at least a portion of the first film of the third dielectric layer. The second film includes an oxide of a zinc alloy. The coated article may have a visible light transmittance in the range of from 40% to 60%. The coated article has a neutral transmitted aesthetic CIELAB L*a*b* color value comprising an a* of greater than −4 and a b* in the range of from −4 to 4.

In another aspect of the present invention, a coated article includes at least a first substrate having a first surface and a second surface opposite of the first surface. A coating may be positioned over one of the surfaces of the first substrate including the following layers. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer is positioned over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The coated article has a neutral transmitted aesthetic CIELAB L*a*b* color value comprising an a* of greater than −4 and a b* in the range of from −4 to 4.

In another aspect of the present invention, a coated article includes at least a first substrate having a first surface and a second surface opposite of the first surface. A coating may be positioned over one of the surfaces of the first substrate including the following layers. A first metallic layer is positioned over at least a portion of the first dielectric layer. A first primer layer is positioned over at least a portion of the first metallic layer. A second dielectric layer is positioned over at least a portion of the first primer layer. The second dielectric layer includes a zinc stannate film. A second metallic layer is positioned over at least a portion of the second dielectric layer. A second primer layer is positioned over at least a portion of the second metallic layer. A third dielectric layer is positioned over at least a portion of the second primer layer. A third metallic layer is positioned over at least a portion of the third dielectric layer. A third primer layer is positioned over at least a portion of the third metallic layer. A fourth dielectric layer is positioned over at least a portion of the third dielectric layer. A protective layer is positioned over at least a portion of the fourth dielectric layer. The second metallic layer is a discontinuous metallic layer having an effective thickness in the range of from 5 Å to 20 Å and is formed directly over at least a portion of the zinc stannate film of the second dielectric layer. The third dielectric layer includes a first film, which has zinc oxide and a thickness in the range of from 1 Å to 50 Å, and a second film over at least a portion of the first film of the third dielectric layer, the second film having an oxide of a zinc alloy. The coated article has a neutral transmitted aesthetic CIELAB L*a*b* color value comprising an a* of greater than −4 and a b* in the range of from −4 to 4.

Various preferred and non-limiting examples or aspects of the present invention will now be described and set forth in the following numbered clauses:

Clause 1: A coated article, comprising: at least a first substrate having a first surface and a second surface opposite of the first surface; and a coating over at least a portion of one of the surfaces of the first substrate, the coating comprising: a first dielectric layer over at least a portion of the substrate; a first metallic layer over at least a portion of the first dielectric layer; a first primer layer over at least a portion of the first metallic layer; a second dielectric layer over at least a portion of the first primer layer, the second dielectric layer comprising a zinc stannate film; a second metallic layer over at least a portion of the second dielectric layer; a second primer layer over at least a portion of the second metallic layer; a third dielectric layer over at least a portion of the second primer layer; a third metallic layer over at least a portion of the third dielectric layer; a third primer layer over at least a portion of the third metallic layer; a fourth dielectric layer over at least a portion of the third dielectric layer; and a protective layer over at least a portion of the fourth dielectric layer; wherein the second metallic layer is a discontinuous metallic layer having an effective thickness in the range of from 5 Å to 20 Å and which is formed directly over at least a portion of the zinc stannate film of the second dielectric layer; wherein the coated article comprises exterior reflectance of between 10% and 50%; and wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

Clause 2: The coated article of clause 1, wherein the substrate is a glass substrate.

Clause 3: The coated article of clause 1 or 2, wherein the first dielectric layer comprises: a first film comprising a zinc alloy oxide film; and a second film over at least a portion of the first film of the first dielectric layer, the second film comprising a zinc oxide film.

Clause 4: The coated article of clause 1 or 2, wherein the first dielectric layer comprises: a first film comprising a tin oxide film; and a second film over at least a portion of the first film of the first dielectric layer, the second film comprising a zinc oxide film.

Clause 5: The coated article of clause 1 or 2, wherein the first dielectric layer comprises: a first film comprising a tin oxide film; and a second film over at least a portion of the first film of the first dielectric layer, the second film comprising a zinc alloy oxide film.

Clause 6: The coated article of any one of clauses 1-5, wherein the second dielectric layer comprises a zinc oxide film positioned between the first primer layer and the zinc stannate film of the second dielectric layer.

Clause 7: The coated article of any one of clauses 1-6, wherein the fourth dielectric layer comprises: a first film comprising a zinc oxide film; and a second film over at least a portion of the first film of the fourth dielectric layer, the second film comprising a zinc alloy oxide film.

Clause 8: The coated article of any one of clauses 1-7, wherein the third dielectric layer comprises a first film comprising: zinc oxide and having a thickness in the range of from 1 Å to 50 Å, or zinc stannate.

Clause 9: The coated article of clause 8, wherein the third dielectric layer comprises: the first film comprising zinc oxide and having a thickness in the range of from 1 Å to 50 Å; and a second film over at least a portion of the first film of the third dielectric layer, the second film comprising an oxide of a zinc alloy.

Clause 10: The coated article of clause 9, wherein the first film of the third dielectric layer has a thickness in the range of from 5 Å to 20 Å.

Clause 11: The coated article of clause 9 or 10, wherein the zinc oxide of the first film of the third dielectric layer comprises at least one dopant.

Clause 12: The coated article of clause 11, wherein the at least one dopant comprises aluminum.

Clause 13: The coated article of any one of clauses 9-11, wherein the zinc oxide of the first film of the third dielectric layer is in direct contact with the second primer layer.

Clause 14: The coated article of any one of clauses 9-13, wherein the third dielectric layer further comprises: a third film over at least a portion of the second film, the third film comprising zinc oxide.

Clause 15: The coated article of clause 8, wherein the third dielectric layer comprises: the first film comprising zinc stannate; and a second film over at least a portion of the first film of the third dielectric layer, the second film comprising zinc oxide.

Clause 16: The coated article of clause 15, wherein the first film of the third dielectric layer has a thickness in the range of from 250 Å to 450 Å.

Clause 17: The coated article of clause 15 or 16, wherein the zinc stannate of the first film of the third dielectric layer is in direct contact with the second primer layer.

Clause 18: The coated article of any one of clauses 1-17, wherein the first primer layer, the second primer layer, and the third primer layer each independently comprise titanium, zinc aluminum, nickel chromium, or a combination thereof.

Clause 19: The coated article of any one of clauses 1-18, wherein the second primer layer comprises titanium.

Clause 20: The coated article of any one of clauses 1-19, wherein the coated article comprises only the first substrate.

Clause 21: The coated article of clause 20, further comprising a visible light transmittance in the range of from 42% to 58%.

Clause 22: The coated article of clause 20 or 21, wherein the exterior reflectance is in the range of from 15% to 25%.

Clause 23: The coated article of any one of clauses 20-22, further comprising an interior reflectance of less than 11%.

Clause 24: The coated article of any one of clauses 20-23, further comprising a transmitted aesthetic CIELAB L*a*b* color value of L* in the range of from 72 to 80, a* in the range of from −5 to −2, and b* in the range of from −2 to 5 when the first substrate is a clear glass substrate.

Clause 25: The coated article of any one of clauses 1-19, wherein the coated article comprises a second substrate spaced apart from the first substrate.

Clause 26: The coated article of clause 25, wherein the coated article is an insulating glass unit.

Clause 27: The coated article of clause 25 or 26, further comprising a visible light transmittance in the range of from 40% to 55%.

Clause 28: The coated article of any one of clauses 25-27, wherein the exterior reflectance is in the range of from 20% to 30%.

Clause 29: The coated article of any one of clauses 25-28, further comprising an interior reflectance of less than 18%.

Clause 30: The coated article of any one of clauses 25-29, further comprising a solar heat gain coefficient in the range of from 0.2 to 0.3.

Clause 31: The coated article of any one of clauses 25-30, further comprising a U-value of less than 0.30.

Clause 32: The coated article of any one of clauses 25-31, further comprising an exterior reflective aesthetic CIELAB L*a*b* color value of L* in the range of from 55 to 60, a* in the range of from −3 to 0, and b* in the range of from −7 to −3; and an interior reflective aesthetic CIELAB L*a*b* color value of L* in the range of from 47 to 50, a* in the range of from −6 to −4, and b* in the range of from −16 to −12.

Clause 33: The coated article of any one of clauses 1-32, wherein the second dielectric layer and the third dielectric layer have a combined thickness in the range of from 700 Å to 950 Å.

Clause 34: The coated article of any one of clauses 1-33, wherein the first dielectric layer has a thickness in the range of from 250 Å to 350 Å, and the fourth dielectric layer has a thickness in the range of from 250 Å to 350 Å.

Clause 35: The coated article of any one of clauses 1-34, wherein the first metallic layer has a thickness in the range of from 125 Å to 225 Å.

Clause 36: The coated article of any one of clauses 1-35, wherein the second primer layer has a thickness in the range of from 5 Å to 30 Å.

Clause 37: The coated article of any one of clauses 1-36, wherein the third metallic layer has a thickness in the range of from 125 Å to 225 Å.

Clause 38: The coated article of any one of clauses 1-37, wherein the third metallic layer has a thickness in the range of from 125 Å to 175 Å.

Clause 39: The coated article of any one of clauses 1-38, wherein the third primer layer has a thickness in the range of from 10 Å to 40 Å.

Clause 40: The coated article of any one of clauses 1-39, wherein the protective layer has a thickness in the range of from 25 Å to 65 Å.

Clause 41: A method of forming a coated article comprising the steps of: providing at least a first substrate having a first surface and a second surface opposite of the first surface; and applying a coating over one of the surfaces of the first substrate, the applying the coating step comprising: applying a first dielectric layer over at least a portion of the substrate; applying a first metallic layer over at least a portion of the first dielectric layer; applying a first primer layer over at least a portion of the first metallic layer; applying a second dielectric layer over at least a portion of the first primer layer; applying a second metallic layer over at least a portion of the second dielectric layer; applying a second primer layer over at least a portion of the second metallic layer; applying a third dielectric layer over at least a portion of the second primer layer; applying a third metallic layer over at least a portion of the third dielectric layer; applying a third primer layer over at least a portion of the third metallic layer; applying a fourth dielectric layer over at least a portion of the third dielectric layer; and applying a protective layer over at least a portion of the fourth dielectric layer; wherein the applying the second dielectric layer step comprises applying a zinc stannate film; wherein the second metallic layer is a discontinuous metallic layer having a thickness in the range of from 5 Å to 20 Å and which is formed directly over at least a portion of the zinc stannate film of the second dielectric layer; wherein the coated article comprises exterior reflectance of between 10% and 50%; and wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

Clause 42: The method of clause 41, wherein the substrate is a glass substrate.

Clause 43: The method of clause 41 or 42, wherein the applying the first dielectric layer step comprises: applying a first film comprising a zinc alloy oxide film; and applying a second film over at least a portion of the first film of the first dielectric layer, the second film comprising a zinc oxide film.

Clause 44: The coated article of clause 41 or 42, wherein the applying the first dielectric layer step comprises: applying a first film comprising a tin oxide film; and applying a second film over at least a portion of the first film of the first dielectric layer, the second film comprising a zinc oxide film.

Clause 45: The coated article of clause 41 or 42, wherein the applying the first dielectric layer step comprises: applying a first film comprising a tin oxide film; and applying a second film over at least a portion of the first film of the first dielectric layer, the second film comprising a zinc alloy oxide film.

Clause 46: The method of any one of clauses 41-45, wherein the applying the second dielectric layer step further comprises applying a zinc oxide film between the first primer layer and the zinc stannate film of the second dielectric layer.

Clause 47: The method of any one of clauses 41-46, wherein the applying the fourth dielectric layer step comprises: applying a first film comprising a zinc oxide film; and applying a second film over at least a portion of the first film of the fourth dielectric layer, the second film comprising a zinc alloy oxide film.

Clause 48: The method of any one of clauses 41-47, wherein the applying a third dielectric layer step comprises applying a first film; wherein the first film comprises: zinc oxide and having a thickness in the range of from 1 Å to 50 Å, or zinc stannate.

Clause 49: The method of clause 48, wherein the applying a third dielectric layer step comprises: applying the first film comprising zinc oxide and having a thickness in the range of from 1 Å to 50 Å; and applying a second film over at least a portion of the first film of the third dielectric layer, the second film comprising an oxide of a zinc alloy.

Clause 50: The method of clause 49, wherein the first film of the third dielectric layer has a thickness in the range of from 5 Å to 20 Å.

Clause 51: The method of clause 49 or 50, wherein the zinc oxide of the first film of the third dielectric layer comprises at least one dopant.

Clause 52: The method of clause 51, wherein the at least one dopant comprises aluminum.

Clause 53: The method of any one of clauses 49-52, wherein the zinc oxide of the first film of the third dielectric layer is in direct contact with the second primer layer.

Clause 54: The method of any one of clauses 49-53, wherein the applying a third dielectric layer step further comprises: applying a third film over at least a portion of the second film, the third film comprising zinc oxide.

Clause 55: The method of clause 48, wherein the applying a third dielectric layer step comprises: applying the first film comprising zinc stannate; and applying a second film over at least a portion of the first film of the third dielectric layer, the second film comprising zinc oxide.

Clause 56: The method of clause 55, wherein the first film of the third dielectric layer has a thickness in the range of from 250 Å to 450 Å.

Clause 57: The method of clause 55 or 56, wherein the zinc stannate of the first film of the third dielectric layer is in direct contact with the second primer layer.

Clause 58: The method of any one of clauses 41-57, wherein the first primer layer, the second primer layer, and the third primer layer comprise titanium, zinc aluminum, nickel chromium, or a combination thereof.

Clause 59: The method of any one of clauses 41-58, wherein the second primer layer comprises titanium.

Clause 60: The method of any one of clauses 41-59, wherein the coated article comprises only the first substrate.

Clause 61: The method of clause 60, wherein the coated article comprises a visible light transmittance in the range of from 42% to 58%.

Clause 62: The method of clause 60 or 61, wherein the coated article comprises an exterior reflectance is in the range of from 15% to 25%.

Clause 63: The method of any one of clauses 60-62, wherein the coated article comprises an interior reflectance of less than 11%.

Clause 64: The method of any one of clauses 60-63, wherein the coated article comprises a transmitted aesthetic CIELAB L*a*b* color value of L* in the range of from 72 to 80, a* in the range of from −5 to −2, and b* in the range of from −2 to 5 when the first substrate is a clear glass substrate.

Clause 65: The method of any one of clauses 41-59, wherein the coated article comprises a second substrate spaced apart from the first substrate.

Clause 66: The method of clause 65, wherein the coated article is an insulating glass unit.

Clause 67: The method of clause 65 or 66, wherein the coated article comprises a visible light transmittance in the range of from 40% to 55%.

Clause 68: The method of any one of clauses 65-67, wherein the coated article comprises an exterior reflectance is in the range of from 20% to 30%.

Clause 69: The method of any one of clauses 65-68, wherein the coated article comprises an interior reflectance of less than 18%.

Clause 70: The method of any one of clauses 65-69, wherein the coated article comprises a solar heat gain coefficient in the range of from 0.2 to 0.3.

Clause 71: The method of any one of clauses 65-70, wherein the coated article comprises a U-value of less than 0.30.

Clause 72: The method of any one of clauses 65-71, wherein the coated article comprises an exterior reflective aesthetic CIELAB L*a*b* color value of L* in the range of from 55 to 60, a* in the range of from −3 to 0, and b* in the range of from −7 to −3; and an interior reflective aesthetic CIELAB L*a*b* color value of L* in the range of from 47 to 50, a* in the range of from −6 to −4, and b* in the range of from −16 to −12.

Clause 73: The method of any one of clauses 41-72, wherein the second dielectric layer and the third dielectric layer have a combined thickness of from 700 Å to 950 Δ.

Clause 74: The method of any one of clauses 41-73, wherein the first dielectric layer has a thickness in the range of from 250 Å to 350 Å, and the fourth dielectric layer has a thickness in the range of from 250 Å to 350 Å.

Clause 75: The method of any one of clauses 41-74, wherein the first metallic layer has a thickness in the range of from 125 Å to 225 Å.

Clause 76: The method of any one of clauses 41-75, wherein the second primer layer has a thickness in the range of from 5 Å to 30 Å.

Clause 77: The method of any one of clauses 41-76, wherein the third metallic layer has a thickness in the range of from 125 Å to 225 Å.

Clause 78: The method of any one of clauses 41-77, wherein the thickness of the third metallic layer is in the range of from 125 Å to 175 Å.

Clause 79: The method of any one of clauses 41-78, wherein the third primer layer has a thickness in the range of from 10 Å to 40 Å.

Clause 80: The method of any one of clauses 41-79, wherein the protective layer has a thickness in the range of from 25 Å to 60 Å.

Clause 81: A coated article, comprising: at least a first substrate having a first surface and a second surface opposite of the first surface; and a coating over at least a portion of one of the surfaces of the first substrate, the coating comprising: a first dielectric layer over at least a portion of the substrate; a first metallic layer over at least a portion of the first dielectric layer; a first primer layer over at least a portion of the first metallic layer; a second dielectric layer over at least a portion of the first primer layer, the second dielectric layer comprising a zinc stannate film; a second metallic layer over at least a portion of the second dielectric layer; a second primer layer over at least a portion of the second metallic layer; a third dielectric layer over at least a portion of the second primer layer; a third metallic layer over at least a portion of the third dielectric layer; a third primer layer over at least a portion of the third metallic layer; a fourth dielectric layer over at least a portion of the third dielectric layer; and a protective layer over at least a portion of the fourth dielectric layer; wherein the second metallic layer is a discontinuous metallic layer having an effective thickness in the range of from 5 Å to 20 Å and which is formed directly over at least a portion of the zinc stannate film of the second dielectric layer; wherein the coated article comprises a visible light transmittance in the range of from 40% to 60%; and wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

Clause 82: The coated article of clause 81, wherein the substrate is a glass substrate.

Clause 83: The coated article of clause 81 or 82, wherein the first dielectric layer comprises: a first film comprising a zinc alloy oxide film; and a second film over at least a portion of the first film of the first dielectric layer, the second film comprising a zinc oxide film.

Clause 84: The coated article of clause 81 or 82, wherein the first dielectric layer comprises: a first film comprising a tin oxide film; and a second film over at least a portion of the first film of the first dielectric layer, the second film comprising a zinc oxide film.

Clause 85: The coated article of clause 81 or 82, wherein the first dielectric layer comprises: a first film comprising a tin oxide film; and a second film over at least a portion of the first film of the first dielectric layer, the second film comprising a zinc alloy oxide film.

Clause 86: The coated article of any one of clauses 81-85, wherein the second dielectric layer comprises a zinc oxide film positioned between the first primer layer and the zinc stannate film of the second dielectric layer.

Clause 87: The coated article of any one of clauses 81-86, wherein the fourth dielectric layer comprises: a first film comprising a zinc oxide film; and a second film over at least a portion of the first film of the fourth dielectric layer, the second film comprising a zinc alloy oxide film.

Clause 88: The coated article of any one of clauses 81-87, wherein the third dielectric layer comprises a first film comprising: zinc oxide and having a thickness in the range of from 1 Å to 50 Å, or zinc stannate.

Clause 89: The coated article of clause 88, wherein the third dielectric layer comprises: the first film comprising zinc oxide and having a thickness in the range of from 1 Å to 50 Å; and a second film over at least a portion of the first film of the third dielectric layer, the second film comprising an oxide of a zinc alloy.

Clause 90: The coated article of clause 89, wherein the first film of the third dielectric layer has a thickness in the range of from 5 Å to 20 Å.

Clause 91: The coated article of clause 89 or 90, wherein the zinc oxide of the first film of the third dielectric layer comprises at least one dopant.

Clause 92: The coated article of clause 91, wherein the at least one dopant comprises aluminum.

Clause 93: The coated article of any one of clauses 89-92, wherein the zinc oxide of the first film of the third dielectric layer is in direct contact with the second primer layer.

Clause 94: The coated article of any one of clauses 89-93, wherein the third dielectric layer further comprises: a third film over at least a portion of the second film, the third film comprising zinc oxide.

Clause 95: The coated article of clause 88, wherein the third dielectric layer comprises: the first film comprising zinc stannate; and a second film over at least a portion of the first film of the third dielectric layer, the second film comprising zinc oxide.

Clause 96: The coated article of clause 95, wherein the first film of the third dielectric layer has a thickness in the range of from 250 Å to 450 Å.

Clause 97: The coated article of clause 95 or 96, wherein the zinc stannate of the first film of the third dielectric layer is in direct contact with the second primer layer.

Clause 98: The coated article of any one of clauses 81-97, wherein the first primer layer, the second primer layer, and the third primer layer comprise titanium, zinc aluminum, nickel chromium, or a combination thereof.

Clause 99: The coated article of any one of clauses 81-98, wherein the second primer layer comprises titanium.

Clause 100: The coated article of any one of clauses 81-99, wherein the coated article comprises only the first substrate.

Clause 101: The coated article of clause 100, further comprising a visible light transmittance in the range of from 42% to 58%.

Clause 102: The coated article of clause 100 or 101, wherein the exterior reflectance is in the range of from 15% to 25%.

Clause 103: The coated article of any one of clauses 100-102, further comprising an interior reflectance of less than 11%.

Clause 104: The coated article of any one of clauses 100-103, further comprising a transmitted aesthetic CIELAB L*a*b* color value of L* in the range of from 72 to 80, a* in the range of from −5 to −2, and b* in the range of from −2 to 5 when the first substrate is a clear glass substrate.

Clause 105: The coated article of any one of clauses 81-99, wherein the coated article comprises a second substrate spaced apart from the first substrate.

Clause 106: The coated article of clause 105, wherein the coated article is an insulating glass unit.

Clause 107: The coated article of clause 105 or 106, further comprising a visible light transmittance in the range of from 40% to 55%.

Clause 108: The coated article of any one of clauses 105-107, wherein the exterior reflectance is in the range of from 20% to 30%.

Clause 109: The coated article of any one of clauses 105-108, further comprising an interior reflectance of less than 18%.

Clause 110: The coated article of any one of clauses 105-109, further comprising a solar heat gain coefficient in the range of from 0.2 to 0.3.

Clause 111: The coated article of any one of clauses 105-110, further comprising a U-value of less than 0.30.

Clause 112: The coated article of any one of clauses 105-111, further comprising an exterior reflective aesthetic CIELAB L*a*b* color value of L* in the range of from 55 to 60, a* in the range of from −3 to 0, and b* in the range of from −7 to −3; and an interior reflective aesthetic CIELAB L*a*b* color value of L* in the range of from 47 to 50, a* in the range of from −6 to −4, and b* in the range of from −16 to −12.

Clause 113: The coated article of any one of clauses 81-112, wherein the second dielectric layer and the third dielectric layer have a combined thickness in the range of from 700 Å to 950 Å.

Clause 114: The coated article of any one of clauses 81-113, wherein the first dielectric layer has a thickness in the range of from 250 Å to 350 Å, and the fourth dielectric layer has a thickness in the range of from 250 Å to 350 Å.

Clause 115: The coated article of any one of clauses 81-114, wherein the first metallic layer has a thickness in the range of from 125 Å to 225 Å.

Clause 116: The coated article of any one of clauses 81-115, wherein the second primer layer has a thickness in the range of from 5 Å to 30 Å.

Clause 117: The coated article of any one of clauses 81-116, wherein the third metallic layer has a thickness in the range of from 125 Å to 225 Å.

Clause 118: The coated article of any one of clauses 81-117, wherein the third metallic layer has a thickness in the range of from 125 Å to 175 Å.

Clause 119: The coated article of any one of clauses 81-118, wherein the third primer layer has a thickness in the range of from 10 Å to 40 Å.

Clause 120: The coated article of any one of clauses 81-119, wherein the protective layer has a thickness in the range of from 25 Å to 65 Å.

Clause 121: A coated article, comprising: at least a first substrate having a first surface and a second surface opposite of the first surface; and a coating over at least a portion of one of the surfaces of the first substrate, the coating comprising: a first metallic layer over at least a portion of the first dielectric layer; a first primer layer over at least a portion of the first metallic layer; a second dielectric layer over at least a portion of the first primer layer, the second dielectric layer comprising a zinc stannate film; a second metallic layer over at least a portion of the second dielectric layer; a second primer layer over at least a portion of the second metallic layer; a third dielectric layer over at least a portion of the second primer layer; a third metallic layer over at least a portion of the third dielectric layer; a third primer layer over at least a portion of the third metallic layer; a fourth dielectric layer over at least a portion of the third dielectric layer; and a protective layer over at least a portion of the fourth dielectric layer; wherein the second metallic layer is a discontinuous metallic layer having an effective thickness in the range of from 5 Å to 20 Å and which is formed directly over at least a portion of the zinc stannate film of the second dielectric layer; and wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

Clause 122: The coated article of clause 121, wherein the substrate is a glass substrate.

Clause 123: The coated article of clause 121 or 122, wherein the first dielectric layer comprises: a first film comprising a zinc alloy oxide film; and a second film over at least a portion of the first film of the first dielectric layer, the second film comprising a zinc oxide film.

Clause 124: The coated article of clause 121 or 122, wherein the first dielectric layer comprises: a first film comprising a tin oxide film; and a second film over at least a portion of the first film of the first dielectric layer, the second film comprising a zinc oxide film.

Clause 125: The coated article of clause 121 or 122, wherein the first dielectric layer comprises: a first film comprising a tin oxide film; and a second film over at least a portion of the first film of the first dielectric layer, the second film comprising a zinc alloy oxide film.

Clause 126: The coated article of any one of clauses 121-125, wherein the second dielectric layer comprises a zinc oxide film positioned between the first primer layer and the zinc stannate film of the second dielectric layer.

Clause 127: The coated article of any one of clauses 121-126, wherein the fourth dielectric layer comprises: a first film comprising a zinc oxide film; and a second film over at least a portion of the first film of the fourth dielectric layer, the second film comprising a zinc alloy oxide film.

Clause 128: The coated article of any one of clauses 121-127, wherein the third dielectric layer comprises a first film comprising: zinc oxide and having a thickness in the range of from 1 Å to 50 Å, or zinc stannate.

Clause 129: The coated article of clause 128, wherein the third dielectric layer comprises: the first film comprising zinc oxide and having a thickness in the range of from 1 Å to 50 Å; and a second film over at least a portion of the first film of the third dielectric layer, the second film comprising an oxide of a zinc alloy.

Clause 130: The coated article of clause 129, wherein the first film of the third dielectric layer has a thickness in the range of from 5 Å to 20 Å.

Clause 131: The coated article of clause 129 or 130, wherein the zinc oxide of the first film of the third dielectric layer comprises at least one dopant.

Clause 132: The coated article of clause 131, wherein the at least one dopant comprises aluminum.

Clause 133: The coated article of any one of clauses 129-132, wherein the zinc oxide of the first film of the third dielectric layer is in direct contact with the second primer layer.

Clause 134: The coated article of any one of clauses 129-133, wherein the third dielectric layer further comprises: a third film over at least a portion of the second film, the third film comprising zinc oxide.

Clause 135: The coated article of clause 128, wherein the third dielectric layer comprises: the first film comprising zinc stannate; and a second film over at least a portion of the first film of the third dielectric layer, the second film comprising zinc oxide.

Clause 136: The coated article of clause 135, wherein the first film of the third dielectric layer has a thickness in the range of from 250 Å to 450 Å.

Clause 137: The coated article of clause 135 or 136, wherein the zinc stannate of the first film of the third dielectric layer is in direct contact with the second primer layer.

Clause 138: The coated article of any one of clauses 121-137, wherein the first primer layer, the second primer layer, and the third primer layer comprise titanium, zinc aluminum, nickel chromium, or a combination thereof.

Clause 139: The coated article of any one of clauses 121-138, wherein the second primer layer comprises titanium.

Clause 140: The coated article of any one of clauses 121-139, wherein the coated article comprises only the first substrate.

Clause 141: The coated article of clause 140, further comprising a visible light transmittance in the range of from 42% to 58%.

Clause 142: The coated article of clause 140 or 141, wherein the exterior reflectance is in the range of from 15% to 25%.

Clause 143: The coated article of any one of clauses 140-142, further comprising an interior reflectance of less than 11%.

Clause 144: The coated article of any one of clauses 140-143, further comprising a transmitted aesthetic CIELAB L*a*b* color value of L* in the range of from 72 to 80, a* in the range of from −5 to −2, and b* in the range of from −2 to 5 when the first substrate is a clear glass substrate.

Clause 145: The coated article of any one of clauses 121-139, wherein the coated article comprises a second substrate spaced apart from the first substrate.

Clause 146: The coated article of clause 145, wherein the coated article is an insulating glass unit.

Clause 147: The coated article of clause 145 or 146, further comprising a visible light transmittance in the range of from 40% to 55%.

Clause 148: The coated article of any one of clauses 145-147, wherein the exterior reflectance is in the range of from 20% to 30%.

Clause 149: The coated article of any one of clauses 145-148, further comprising an interior reflectance of less than 18%.

Clause 150: The coated article of any one of clauses 145-149, further comprising a solar heat gain coefficient in the range of from 0.2 to 0.3.

Clause 151: The coated article of any one of clauses 145-150, further comprising a U-value of less than 0.30.

Clause 152: The coated article of any one of clauses 145-151, further comprising an exterior reflective aesthetic CIELAB L*a*b* color value of L* in the range of from 55 to 60, a* in the range of from −3 to 0, and b* in the range of from −7 to −3; and an interior reflective aesthetic CIELAB L*a*b* color value of L* in the range of from 47 to 50, a* in the range of from −6 to −4, and b* in the range of from −16 to −12.

Clause 153: The coated article of any one of clauses 121-152, wherein the second dielectric layer and the third dielectric layer have a combined thickness in the range of from 700 Å to 950 Å.

Clause 154: The coated article of any one of clauses 121-153, wherein the first dielectric layer has a thickness in the range of from 250 Å to 350 Å, and the fourth dielectric layer has a thickness in the range of from 250 Å to 350 Å.

Clause 155: The coated article of any one of clauses 121-154, wherein the first metallic layer has a thickness in the range of from 125 Å to 225 Å.

Clause 156: The coated article of any one of clauses 121-155, wherein the second primer layer has a thickness in the range of from 5 Å to 30 Å.

Clause 157: The coated article of any one of clauses 121-156, wherein the third metallic layer has a thickness in the range of from 125 Å to 225 Å.

Clause 158: The coated article of any one of clauses 121-157, wherein the third metallic layer has a thickness in the range of from 125 Å to 175 Å.

Clause 159: The coated article of any one of clauses 121-158, wherein the third primer layer has a thickness in the range of from 10 Å to 40 Å.

Clause 160: The coated article of any one of clauses 121-159, wherein the protective layer has a thickness in the range of from 25 Å to 65 Å.

### BRIEF DESCRIPTION OF THE DRAWINGS

The invention will be described with reference to the following drawing figures.

FIG. 1 is a side view (not to scale) of an insulating glass unit (IGU) having a coating according to one aspect of the present invention;

FIG. 2 is a side view (not to scale of a coating according to another aspect of the present invention; and

FIG. 3 is a side, sectional view (not to scale) of a subcritical metal layer with a primer layer according to another aspect of the present invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. As used herein, the terms “polymer” or “polymeric” include oligomers, homopolymers, copolymers, and terpolymers, e.g., polymers formed from two or more types of monomers or polymers. The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The terms “metal” and “metal oxide” include silicon and silica, respectively, as well as traditionally recognized metals and metal oxides, even though silicon conventionally may not be considered a metal. Thickness values, unless indicated to the contrary, are geometric thickness values.

The discussion of the invention may describe certain features as being “particularly” or “preferably” within certain limitations (e.g., “preferably”, “more preferably”, or “most preferably”, within certain limitations). It is to be understood that the invention is not limited to these particular or preferred limitations but encompasses the entire scope of the disclosure.

The color coordinates a*, b*, and L* are those of the conventional CIE (1931) and CIELAB systems that will be understood by one of ordinary skill in the art.

A “standard IGU” has an outer ply of 6 mm thick glass, an inner ply of 6 mm glass, a 0.5 inch (1.27 cm) gap filled with air, with the coating on the No. 2 surface. The glass used in the IGU may be any glass know in the art. For example, the glass used in the IGU may be clear glass substrates, such as Vitro CLEAR glass, commercially available from Vitro Flat Glass LLC.

For purposes of the following disclosure, the invention will be discussed with reference to use with an architectural transparency, such as, but not limited to, an IGU. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles. Therefore, it is to be understood that the specifically disclosed exemplary embodiments are presented simply to explain the general concepts of the invention, and that the invention is not limited to these specific exemplary embodiments.

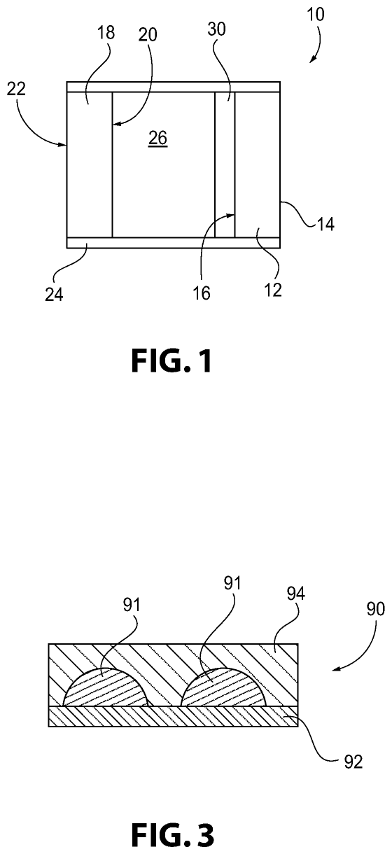

A non-limiting transparency 10 incorporating features of the invention is illustrated in FIG. 1. The transparency 10 can have any desired visible light, infrared radiation, or ultraviolet radiation transmission and/or reflection. For example, the transparency 10 can have a visible light transmission of any desired amount, e.g., greater than 0% and up to 100%.

The non-limiting, exemplary transparency 10 of FIG. 1 is in the form of a conventional insulating glass unit and includes a first ply 12 with a first major surface 14 (No. 1 surface) and an opposed second major surface 16 (No. 2 surface). In the illustrated non-limiting embodiment, the first major surface 14 faces the building exterior, i.e., is an outer major surface, and the second major surface 16 faces the interior of the building. The transparency 10 also includes a second ply 18 having an outer (first) major surface 20 (No. 3 surface) and an inner (second) major surface (No. 4 surface) and spaced from the first ply 12. This numbering of the ply surfaces is in keeping with conventional practice in the fenestration art. The first and second plies 12, 18 can be connected together in any suitable manner, such as by being adhesively bonded to a conventional spacer frame 24. A gap or chamber 26 is formed between the two plies 12, 18. The chamber 26 can be filled with a selected atmosphere, such as air, or a non-reactive gas such as argon or krypton gas. A reflective coating 30 (or any of the other coatings described below) is formed over at least a portion of one of the plies 12, 18, such as, but not limited to, over at least a portion of the No. 2 surface 16 or at least a portion of the No. 3 surface 20. Although, the coating could also be on the No. 1 surface or the No. 4 surface, if desired. Examples of insulating glass units are found, for example, in U.S. Pat. Nos. 4,193,236; 4,464,874; 5,088,258; and 5,106,663.

In the broad practice of the invention, the plies 12, 18 of the transparency 10 can be of the same or different materials. The plies 12, 18 can include any desired material having any desired characteristics. For example, on or more of the plies 12, 18 can be transparent or translucent to visible light. By “transparent” is meant having visible light transmission of greater than 0% and up to 100%. Alternatively, one or more of the plies 12, 18 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polpropyleneterephthalates, polybutyleneterephthalates, and the like; polysiloxane-containing polymers; or copoylmers of any monomers for preparing these, or any mixtures thereof); ceramic substrates; glass substrates; or mixtures or combinations of any of the above. For example, one or more of the plies 12, 18 can include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be heat-treated glass. As used herein, the term “heat-treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to for a float glass ribbon. Examples of float glass processes are disclosed in U.S. Pat. Nos. 4,466,562 and 4,671,155.

The first and second plies 12, 18 can each be, for example, clear float glass or can be tinted or colored glass or one ply 12, 18 can be clear glass and the other ply 12, 18 colored glass. Although not limited to the invention, examples of glass suitable for the first ply 12 and/or second ply 18 are described in U.S. Pat. Nos. 4,746,347; 4,792,536; 5,030,593; 5,030,594; 5,240,886; 5,385,872; and 5,393,593. The first and second plies 12, 18 can be of any desired dimensions, e.g., length, width, shape, or thickness. In one exemplary automotive transparency, the first and second plies can each be 1 mm to 10 mm thick, such as 1 mm to 8 mm thick, such as 2 mm to 8 mm, such as 3 mm to 7 mm, such as 5 mm to 7 mm, such as 6 mm thick.

The reflective coating 30 of the invention is deposited over at least a portion of at least one major surface of one of the glass plies 12, 18. In the example shown in FIG. 1, the coating 30 is formed over at least a portion of the inner surface 16 of the outboard glass ply 12. As used herein, the term “reflective coating” refers to a solar control coating having a visible light reflectance from at least one direction greater than 15%. As used herein, the term “film” refers to a coating region of a desired or selected coating composition. A “layer” can comprise one or more “films” and a “coating” or “coating stack” can comprise one or more “layers”.

The reflective coating 30 can be deposited by any conventional method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, the coating 30 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

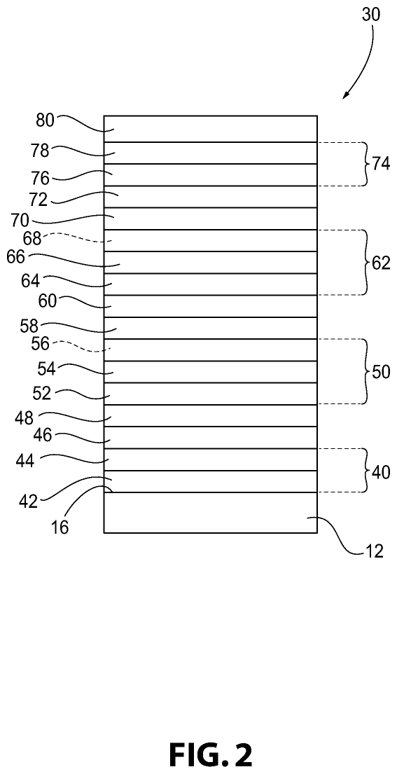

An exemplary non-limiting solar control coating 30 of the invention is shown in FIG. 2. This exemplary coating 30 includes a base layer or first dielectric layer 40 deposited over at least a portion of a major surface of a substrate (e.g., the No. 2 surface 16 of the first ply 12). The first dielectric layer 40 can be a single layer or can comprise more than one film of antireflective materials and/or dielectric materials, such as, but not limited to, metal oxides, oxides of metal alloys, nitrides, oxynitrides, or mixtures thereof. The first dielectric layer 40 can be transparent to visible light. Examples of suitable metal oxides for the first dielectric layer 40 include oxides of titanium, hafnium, aluminum, zirconium, niobium, zinc, bismuth, lead, indium, tin, silicon and mixtures thereof. These metal oxides can have small amounts of other materials, such as manganese and bismuth oxide, tin and indium oxide, etc. Additionally, oxides of metal alloys or metal mixtures can be used, such as oxides containing zinc and tin (e.g., zinc stannate, defined below), oxides of indium-tin alloys, oxides and/or alloys of zinc and aluminum, silicon nitrides, silicon aluminum nitrides, or aluminum nitrides. Further, doped metal oxides, such as aluminum-doped zinc oxides, antimony or indium doped tin oxides or nickel or boron doped silicon oxides, can be used. The first dielectric layer 40 can be a substantially single phase film, such as a metal alloy oxide film, e.g., zinc stannate, or can be a mixture of phases composed of zinc and tin oxides or can be composed of a plurality of films.

For example, the first dielectric layer 40 (whether a single film or multiple film layer) can have a thickness in the range of 100 Å to 500 Å, such as 125 Å to 475 Å, such as 150 Å to 450 Å, such as 175 Å to 425 Å, such as 200 Å to 400 Å, such as 225 Å to 375 Å, such as 250 Å to 350 Å.

The first dielectric layer 40 can comprise a multi-film structure having a first film 42, e.g., a metal alloy oxide film or a metal oxide film, deposited over at least a portion of a substrate (such as the inner major surface 16 of the first ply 12). In one non-limiting embodiment, the first film 42 can be a metal alloy oxide film, such as a zinc/tin alloy oxide. By “zinc/tin alloy oxide” is meant both true alloys and also mixtures of the oxides. The zinc/tin alloy oxide can be that obtained from magnetron sputtering vacuum deposition from a cathode of zinc and tin. One non-limiting cathode can comprise zinc and tin in proportions of 5 wt. % to 95 wt. % zinc and 95 wt. % to 5 wt. % tin, such as 10 wt. % to 90 wt. % zinc and 90 wt. % to 10 wt. % tin. However, other ratios of zinc to tin could also be used. One suitable metal alloy oxide that can be present in the first film 42 is zinc stannate. By “zinc stannate” is meant a composition of ZnxSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=2/3, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the film.

In another non-limiting embodiment, the first film 42 can be a metal oxide film, such as tin oxide. The tin oxide can be deposited in an oxygen (O₂) environment from a tin target or from a tin target that includes other materials to improve the sputtering characteristics of the target. For example, the O₂ flow rate (i.e., concentration of O₂ in the atmosphere for the chamber where the material is being deposited) can be up to 80% O₂, such as, 80% O₂, 75% O₂, or 70% O₂. The remainder of the atmosphere can be an inert gas, such as, argon. The tin oxide can be obtained from magnetron sputtering vacuum deposition from a target of tin or a target of tin and zinc. For example, the tin target can include a small amount (e.g., up to 20 wt. %, up to 15 wt. %, up to 10 wt. %, or up to 5 wt. %) of zinc. In which case, the resultant tin oxide film would include a small percentage of zinc oxide, e.g., up to 20 wt. % zinc oxide, e.g., up to 10 wt. % zinc oxide, e.g., up to 5 wt. % zinc oxide. A coating layer deposited from a tin target having up to from 0 wt. % to 20 wt. % zinc is referred to herein as “a tin oxide film”. The first film 42 of the first dielectric layer 40 may be a tin oxide film where tin is substantially the only metal in the first film 42. As used herein, “substantially free” means that the tin oxide film contains less than 0.5 wt. % of additional metals other than tin. The tin oxide film 42 may include 80 wt. % tin oxide and 20 wt. % zinc oxide. The tin-zinc oxide film 42 may include 90% tin oxide and 10 wt. % zinc oxide.

The first dielectric layer 40 can comprise a second film 44, e.g., a metal oxide or oxide mixture film or metal alloy oxide film, deposited over the first film 42. The second film 44 can be a metal oxide film, such as zinc oxide. The zinc oxide film can be deposited from a zinc cathode that includes other materials to improve the sputtering characteristics of the cathode. For example, the zinc cathode can include a small amount (e.g., up to 10 wt. %, such as up to 5 wt. %) of tin to improve sputtering. In which case, the resultant zinc oxide film would include a small percentage of tin oxide, e.g., up to 10 wt. % tin oxide, e.g., up to 5 wt. % tin oxide. A coating layer deposited from a zinc cathode having up to 10 wt. % tin (added to enhance the conductivity of the cathode) is referred to herein as “a zinc oxide film” even though a small amount of tin may be present. The small amount of tin in the cathode (e.g., less than or equal to 10 wt. %, such as less than or equal to 5 wt. %) is believed to form tin oxide in the predominantly zinc oxide second film 44. Alternatively, the second film 44 may comprise zinc and aluminum, such as an aluminum-doped zinc oxide film. In another non-limiting embodiment, the second film 44 can be a metal alloy oxide film, such as zinc stannate.

For example, the first film 42 can be zinc stannate and the second film 44 can be zinc oxide. As another example, the first film 42 can be tin oxide and the second film 44 can be zinc oxide. As yet another example, the first film 42 can be tin oxide and the second film 44 can be zinc stannate.

The first film 42 may have a thickness in the range of 50 Å to 400 Å, such as 50 Å to 375 Å, such as 75 Å to 350 Å, such as 100 Å to 325 Å, such as 100 Å to 300 Å, such as 125 Å to 275 Å, such as 150 Å to 250 Å. The second film 44 may have a thickness in the range of 30 Å to 150 Å, such as 40 Å to 125 Å, such as 45 Å to 115 Å, such as 50 Å to 100 Å.

A first heat and/or radiation reflective metallic layer 46 can be deposited over the first dielectric layer 40. The first metallic layer 46 can include a reflective metal, such as, but not limited to, metallic gold, copper, palladium, aluminum, silver, or mixtures, alloys, or combinations thereof. In one embodiment, the first metallic layer 46 comprises a metallic silver layer. The first metallic layer 46 may have a thickness in the range of 140 Å to 220 Å, e.g., 140 Å to 215 Å, e.g., 145 Å to 210 Å, such as 150 Å to 205 Å, such as 150 Å to 200 Å, such as 155 Å to 195 Å, such as 160 Å to 190 Å. The first metallic layer 46 may be a continuous or a discontinuous layer. For example, the first metallic layer 46 is a continuous layer. By “continuous layer” is meant that the coating forms a continuous film of the material and not isolated coating regions.

An optional first primer layer 48 is located over the first metallic layer 46. The first primer layer 48 can be a single film or a multiple film layer. The first primer layer 48 can include an oxygen-capturing material that can be sacrificial during the deposition process to prevent degradation or oxidation of the first metallic layer 46 during the sputtering process or subsequent heating processes. The first primer layer 48 can also absorb at least a portion of electromagnetic radiation, such as visible light, passing through the coating 30. Examples of materials useful for the first primer layer 48 include titanium, silicon, silicon dioxide, silicon nitride, silicon oxynitride, nickel-chrome alloys (such as Inconel), zirconium, aluminum, alloys of silicon and aluminum, alloys containing cobalt and chromium (e.g., Stellite®), and mixtures thereof. For example, the first primer layer 48 can be titanium or can be zinc aluminum, such as aluminum-doped zinc oxide. The first primer layer can have a thickness in the range of 10 Å to 50 Å, e.g., 10 Å to 45 Å, e.g., 15 Å to 40 Å, e.g., e.g., 15 Å to 35 Å.

A second dielectric layer 50 is located over the first metallic layer 46 (e.g., over the first primer layer 48). The second dielectric layer 50 can comprise one or more metal oxide or metal alloy oxide-containing films, such as those described above with respect to the first dielectric layer 40. For example, the second dielectric layer 50 can include a first film 52, such as a metal oxide film 52, e.g., a zinc oxide film, deposited over the first primer layer 48 and a second film 54, such as a metal alloy oxide film 54, e.g., a zinc stannate (Zn₂SnO₄) film, deposited over the first film 52. Alternatively, the second film 54 can comprise zinc and aluminum, such as aluminum-doped zinc oxide. An optional third film 56, such as a metal oxide film 56, e.g., another zinc oxide layer, can be deposited over the zinc stannate layer. Alternatively, the second dielectric layer does not include a third film 56. The second film 54, comprising zinc stannate, may be in direct contact with the second metallic layer 58.

The second dielectric layer 50 can have a total thickness (e.g., the combined thicknesses of the films) is in the range of 100 Å to 600 Å, e.g., 125 Å to 575 Å, e.g., 150 Å to 550 Å, e.g., 175 Å to 525 Å, e.g., 200 Å to 500 Å, e.g., 250 Å to 475 Å, e.g., 300 Å to 450 Å.

For example, for a multi-film layer, the first film 52 (and optional third film 56, if present) can have a thickness in the range of 30 Å to 150 Å, e.g., 40 Å to 125 Å, e.g., 45 Å to 100 Å, e.g., 50 Å to 100 Å. The second film 54 can have a thickness in the range of 50 Å to 570 Å, e.g., 100 Å to 550 Å, e.g., 150 Å to 500 Å, e.g., 200 Å to 450 Å, e.g., 200 Å to 400 Å, e.g., 250 Å to 350 Å.

A subcritical thickness (discontinuous) second metallic layer 58 is located over the second dielectric layer 50 (e.g., over the third film 56, if present, or over the second film 54 if not). The metallic material, such as, but not limited to, metallic gold, copper, palladium, aluminum, silver, or mixtures, alloys, or combinations thereof, is applied at a subcritical thickness such that isolated regions or islands of the material are formed rather than a continuous layer of the material. For silver, it has been determined that the critical thickness is less than 50 Å. For silver, the transition between a continuous layer and a subcritical layer occurs in the range of 25 Å to 65 Å. It is estimated that copper, gold, and palladium would exhibit similar subcritical behavior in this range.

An example of a discontinuous metallic layer 90 is shown in FIG. 3. The discontinuous metallic layer 90 has discontinuous coating regions 91 formed on a dielectric layer 92 and covered by a primer layer 94. The subcritical metal thickness causes the metal material to form discontinuous regions or islands of metal or metal oxide on the dielectric layer 92. When the primer layer 94 is applied over the discontinuous metallic layer 90, the material of the primer layer 94 covers the islands and can also extend into the gaps between adjacent islands of the subcritical metal and contact the underlying dielectric layer 92.

The second metallic layer 58 can include any one or more of the materials described above with respect to the first metallic layer 46 but these materials are not present as a continuous film. In one non-limiting embodiment, the second metallic layer 58 comprises islanded silver with the islands having an effective thickness in the range of greater than 0 Å to 100 Å, e.g., 0.5 Å to 75 Å, e.g., 1 Å to 50 Å, e.g., 2 Å to 40 Å, e.g., 5 Å to 30 Å, e.g., 5 Å to 20 Å, e.g., 8 Å to 14 Å, e.g., 9 Å to 12 Å. It is respectfully noted that a range of “greater than 0 Å to 100 Å” should be understood as a range including all values greater than 0 Å and up to 100 Å. The subcritical metallic layer 58 absorbs electromagnetic radiation according to the Plasmon Resonance Theory. This absorption depends at least partly on the boundary conditions at the interface of the metallic islands. The subcritical metallic layer 58 is not an infrared reflecting layer, like the first metallic layer 46. The subcritical silver layer 58 is not a continuous layer.

Also, the thickness values associated with the “subcritical” layers are “effective” thicknesses calculated based on a reference coating speed that is slower than the actual coating speed of the commercial coater. For example, a silver layer is applied onto a substrate at the same coating rate as a commercial coater but at a reduced line speed (reference coating speed) compared to the commercial coater. The thickness of the coating deposited at the reference coating speed is measured and then the “effective thickness” for a coating deposited at the same coating rate but at the faster line speed of the commercial coater is extrapolated. For example, if a particular coating rate provides a silver coating of 250 Å at reference coating speed that is one-tenth the line speed of the commercial coater, then the “effective thickness” of the silver layer at the same coating rate but at the commercial coater line speed (i.e., ten time faster than the reference coating run) is extrapolated to be 25 Å (i.e., one tenth the thickness). However, as will be appreciated, the silver layer at this effective thickness (below the subcritical thickness) would not be a continuous layer but rather would be a discontinuous layer having discontinuous regions of silver material.

An optional second primer layer 60 can be deposited over the second metallic layer 58. The second primer layer 60 can be as described above with respect to the first primer layer 48. In one example, the second primer layer can be titanium, aluminum and zinc, such as aluminum-doped zinc oxide, or nickel-chromium alloy (such as Inconel). The second primer layer 60 can have a thickness in the range of 1 Å to 50 Å, e.g., 1 Å to 40 Å, e.g., 5 Å to 30 Å, e.g., 10 Å to 20 Å. Since the absorbance of the subcritical material depends at least partly on the boundary conditions, different primers (e.g., having different refractive indices) can provide the coating with different absorbance spectra and, hence, with different colors.

A third dielectric layer 62 can be deposited over the second metallic layer 58 (e.g., over the second primer layer 60). The third dielectric layer 62 can also include one or more metal oxide or metal alloy oxide-containing layers, such as discussed above with respect to the first and second dielectric layers 40, 50. In one example, the third dielectric layer 62 is a multi-film layer. For example, the third dielectric layer 62 can include a first film 64. The first film 64 may comprise zinc stannate or zinc oxide. In one non-limiting embodiment, the first film 64 comprises zinc stannate and has a thickness in the range of 100 Å to 500 Å, such as 150 Å to 475 Å, such as 200 Å to 450 Å, such as 300 Å to 425 Å, such as 350 Å to 400 Å. In another non-limiting embodiment, the first film 64 comprises zinc oxide and has a thickness in the range of 1 Å to 100 Å, such as 1 Å to 50 Å, such as 5 Å to 40 Å, such as 5 Å to 30 Å, such as 5 Å to 20 Å. The first film 64 may be in direct contact with the second primer layer 60, if present, or in direct contact with the second metallic layer 58, if not. The third dielectric layer 62 can include a second film 66 over at least a portion of the first film 64. The second film 66 may comprise zinc stannate or zinc oxide. In one non-limiting embodiment, the second film 66 comprises zinc stannate and has a thickness in the range of 100 Å to 500 Å, such as 200 Å to 500 Å, such as 300 Å to 500 Å, such as 350 Å to 500 Å. In another non-limiting embodiment, the second film 66 comprises zinc oxide and has a thickness in the range of 30 Å to 150 Å, such as 35 Å to 125 Å, such as 40 Å to 100 Å, such as 50 Å to 100 Å. The third dielectric layer 62 may have an optional third film 68 over at least a portion of the second film 66. The optional third film 68 may comprise zinc stannate or zinc oxide. For example, the optional third film 68 may comprise zinc oxide and have a thickness in the range of 30 Å to 150 Å, such as 35 Å to 125 Å, such as 40 Å to 100 Å, such as 50 Å to 100 Å. Alternatively, the third dielectric layer may not have a third film 68, such that the second film 66 is in direct contact with the third metallic layer 70. Alternatively, the second film 66 or the optional third film 68 may comprise zinc and aluminum, such as aluminum-doped zinc oxide.

In one example, the total thickness of the third dielectric layer 62 (e.g., the combined thicknesses of the films) is in the range of 100 Å to 700 Å, e.g., 150 Å to 650 Å, e.g., 200 Å to 600 Å, e.g., 250 Å to 550 Å, e.g., 300 Å to 500 Å, e.g., 400 Å to 500 Å.

A third heat and/or radiation reflective metallic layer 70 is deposited over the third dielectric layer 62. The third metallic layer 70 can be of any of the materials discussed above with respect to the first metallic layer 46. In one non-limiting example, the third metallic layer 70 includes silver and has a thickness in the range of 130 Å to 180 Å, e.g., 130 Å to 175 Å, e.g., 140 Å to 170 Å, such as 150 Å to 170 Å. The third metallic layer may be a continuous layer or a discontinuous layer. For example, the third metallic layer is a continuous layer.

An optional third primer layer 72 is located over the third metallic layer 70. The third primer layer 72 can be as described above with respect to the first or second primer layers. In one non-limiting example, the third primer layer comprises titanium or aluminum and zinc, such as aluminum-doped zinc oxide. The optional third primer layer 72 may have a thickness in the range of 10 Å to 50 Å, e.g., 15 Å to 40 Å, e.g., 20 Å to 30 Å.

A fourth dielectric layer 74 is located over the third metallic layer 70 (e.g., over the third primer layer 72). The fourth dielectric layer 74 can be comprised of one or more metal oxide or metal alloy oxide-containing layers, such as those discussed above with respect to the first, second, or third dielectric layers 40, 50, 62. In one non-limiting example, the fourth dielectric layer 74 is a multi-film layer having a first film 76, such as a metal oxide film 76, e.g., a zinc oxide film, deposited over the third primer layer 72, and a second film 78, such as a metal alloy oxide film 78, e.g., a zinc stannate film, deposited over the first film 76. In one non-limiting embodiment, the first film 76 can have a thickness in the range of 30 Å to 150 Å, such as 35 Å to 125 Å, such as 40 Å to 100 Å, such as 50 Å to 100 Å. The second film 78 can have a thickness in the range of 100 Å to 350 Å, e.g., 110 Å to 325 Å, e.g., 120 Å to 300 Å, e.g., 130 Å to 275 Å, e.g., 150 Å to 275 Å, e.g., 160 Å to 240 Å.

In one non-limiting example, the total thickness of the fourth dielectric layer 74 (e.g., the combined thicknesses of the films) is in the range of 200 Å to 450 Å, e.g., 200 Å to 400 Å, e.g., 225 Å to 350 Å, e.g., 250 Å to 325 Å. It is noted that if an optional overcoat or protective layer 80 is present, the thickness of said overcoat or protective layer 80 is included in the total thickness of the fourth dielectric layer 74.

An overcoat or protective layer 80 can be located over the fourth dielectric layer 74. The overcoat 80 can help protect the underlying coating layers from mechanical and chemical attack. The overcoat 80 can be, for example, a metal oxide or metal nitride layer. For example, the overcoat 80 can be titania having a thickness in the range of 25 Å to 100 Å, such as 30 Å to 80 Å, such as 35 Å to 70 Å, such as 40 Å to 65 Å. Other materials useful for the overcoat include other oxides, such as silica, alumina, or a mixture of silica and alumina.

It will be appreciated that the coating can comprise additional layers. For example, the coating may include additional dielectric and/or metal layers. These additional layers can be formed from any of the materials previously described.

In one non-limiting embodiment, the transparency has a visible light transmittance in the range of from 1% to 100%, preferably in the range of from 20% to 75%, more preferably in the range of from 35% to 60%, such as in the range of from 40% to 60%. For example, the transparency may be an IGU having a visible light transmittance in the range of from 43% to 50%. For example, the transparency may be a monolithic coating having a visible light transmittance in the range of from 45% to 60%.

The transparency may be an IGU and may have a solar heat gain coefficient (SHGC) of less than 0.30, such as less than 0.28, such as less than 0.26. For example, the transparency may have an SHGC in the range of from 0.22 to 0.30, preferably in the range of from 0.24 to 0.28, such as about 0.25. The transparency may be an IGU and may have a U-value (Btu/(h*ft²° F.)) of less than 0.40, preferably less than 0.35, more preferably less than 0.32, most preferably less than 0.30, such as a U-value of about 0.28. The “U-value” is the thermal transmittance or rate of transfer of heat through a structure divided by the difference in temperature across said structure. The transparency may be an IGU and may have a light-to-solar gain (LSG) of at least 1, such as at least 1.25, such as 1.5, such as at least 2.2. For example, the transparency may have an LSG in the range of from 1 to 2.2, such as 1 to 2, such as from 1.25 to 1.95, such as from 1.5 to 1.9, such as from 1.7 to 1.9, such as from 1.8 to 1.9, such as about 1.88.

The transparency may have an exterior reflectance in the range of from 1% to 50%, preferably from 10% to 40%, more preferably from 15% to 30%. For example, the transparency may be a monolithic coating having an exterior reflectance in the range of from 20% to 25%. For example, the transparency may be an IGU having an exterior reflectance in the range of from 22% to 28%. As used herein, “exterior reflectance” is the measure of reflectance of the transparency from the uncoated surface (i.e., the substrate side).

The transparency may have an interior reflectance of less than 50%, preferably less than 40%, more preferably less than 25%, most preferably less than 18%. For example, the transparency may be an IGU having an interior reflectance of less than 18%. For example, the transparency may be a monolithic coating having an interior reflectance of less than 12%. As used herein, “interior reflectance” is the measure of reflectance of the transparency from the coated surface (i.e., the coating side).

The transparency may have a desired color. For example, the transparency may have a neutral color. A “neutral” color may be defined herein as having a transmitted aesthetic CIELAB L*a*b* color value of a* greater than −4 and b* in the range of from −4 to 4. For example, the transparency may have a transmitted aesthetic CIELAB L*a*b* color value a* greater than −4 and b* in the range of from −4 to 4 when using a clear glass substrate, such as Vitro CLEAR glass, or a transmitted aesthetic CIELAB L*a*b* color value of a* greater than −3 and b* in the range of from −4 to 4 when using a low-iron substrate, such as Vitro STARPHIRE® glass. The transparency may have a desired transmitted color aesthetic while also exhibiting a desirable reflective aesthetic. For example, the transparency may have a transmitted aesthetic CIELAB L*a*b* color value of a* greater than −4 and b* in the range of from −4 to 4 while maintaining a reflective aesthetic CIELAB L*a*b* color a* value of no less than −10, such as no less than −7, such as no less than −4. The transparency may have the desired transmitted color while also exhibiting a desirable reflected aesthetic and using a clear glass substrate or low-iron substrate. For example, the transparency may have a transmitted aesthetic CIELAB L*a*b* color value of a* greater than −4 and b* in the range of from −4 to 4 while maintaining a reflective aesthetic CIELAB L*a*b* color value a* value of no less than −10, such as no less than −7, such as no less than −4 when using a clear glass substrate such as Vitro CLEAR glass or a low-iron substrate such as Vitro STARPHIRE® glass.

For example, the transparency may have a closer to neutral transmitted aesthetic CIELAB L*a*b* color value compared to a transparency that includes at least two silver layers and which has the same reflective aesthetic CIELAB L*a*b* color value and substrate. The neutral transmitted aesthetic CIELAB L*a*b* color value may be achieved in other transparencies; however, the reflective aesthetic CIELAB L*a*b* color value will have a large negative a* (a*<−4) or one or more properties will be lost, such as LSG, SHGC, and the like. Thus, the present invention has the unexpected benefit of maintaining a neutral transmitted aesthetic CIELAB L*a*b* color value, while also maintaining reflective aesthetic CIELAB L*a*b* color value of a* that is no less than −10, such as no less than −7, such as no less than −4 and maintaining properties such as desired SHGC and LSG. Other transparencies have been found to exhibit an undesirable large negative a* in reflective aesthetic CIELAB L*a*b* color value to achieve the neutral transmitted aesthetic CIELAB L*a*b* color value, or which sacrifice other performance properties, such as LSG. For example, a single silver layer coating may have a neutral transmitted aesthetic CIELAB L*a*b* color value and a desirable a* value for reflective aesthetic CIELAB L*a*b* color value; however, the coating will typically exhibit a decrease in LSG properties.

The transparency may be a monolithic coating having an interior reflective aesthetic CIELAB L*a*b* color value (measured from the coating side) of L* in the range of from 30 to 55, such as from 33 to 50, such as from 35 to 50, such as from 37 to 49; a* in the range of from −12 to 2, such as from −10 to 0, such as from −8 to −3; and a b* in the range of from −25 to −10, such as from −23 to −12, such as from −21 to −13, such as from −21 to −14.

The transparency may be a monolithic coating having an exterior reflective aesthetic CIELAB L*a*b* color value (measured from the substrate side) of L* in the range of from 45 to 70, such as from 48 to 65, such as from 50 to 62, such as from 50 to 60, such as from 52 to 58; a* in the range of from −8 to 1, such as from −5 to 0, such as from −3 to 0, such as from −2.5 to 0; and b* in the range of from −10 to 0, such as from −8 to −2, such as from −7 to −3, such as from −6 to −4, such as from −5.5 to −4.

The transparency may be a monolithic coating having a transmitted aesthetic CIELAB L*a*b* color value of L* in the range of from 60 to 90, such as from 65 to 85, such as from 70 to 82, such as from 72 to 80; a* in the range of from −10 to 0, such as from −8 to −1, such as from −6 to −2, such as from −5 to −2; and b* in the range of from −5 to 10, such as from −2 to 5, such as from 0 to 2.

The transparency may be an insulating glass unit having a transmitted aesthetic CIELAB L*a*b* color value of L* in the range of from 60 to 90, such as from 65 to 85, such as from 70 to 80, such as from 72 to 76; a* in the range of from −10 to 0, such as from −8 to −2, such as from −7 to −3, such as from −6 to −3; and b* in the range of from −4 to 7, such as from −3 to 6, such as from −2 to 5, such as from −1 to 4, such as from −1 to 3, such as from 0 to 3.

The transparency may be an insulating glass unit having an exterior reflective aesthetic CIELAB L*a*b* color value (measured from the substrate side) of L* in the range of from 40 to 65, such as from 45 to 60, such as from 50 to 60, such as from 55 to 60; a* in the range of from −10 to 4, such as from −8 to 2, such as from −5 to 0, such as from −3 to 0; and b* in the range of from −12 to 2, such as from −10 to 0, such as from −8 to −1, such as from −7 to −3.

The transparency may be an insulating glass unit having an interior reflective aesthetic CIELAB L*a*b* color value (measured from the coating side) of L* in the range of from 35 to 65, such as from 40 to 60, such as from 45 to 55, such as from 45 to 52, such as from 47 to 50; a* in the range of from −10 to 0, such as from −8 to −2, such as from −7 to −3, such as from −6 to −4; and b* in the range of from −25 to −5, such as from −20 to −7, such as from −18 to −10, such as from −16 to −12.

Properties in the specification and below Examples were measured as follows. Visible light transmittance, visible light exterior reflectance, visible light interior reflectance, solar transmittance, solar exterior reflectance, solar interior reflectance, and UV transmittance were determined using a Perkin Elmer 1050 Spectrophotometer. Reference IGU values, including Shading Coefficient (SC), Solar Heat Gain Coefficient (SHGC), Light-to-Solar Gain (LSG), unless indicated to the contrary, are those determined in accordance with OPTICS (v6.0) software and WINDOW (v7.6.4) software available from Lawrence Berkeley National Laboratory, measured center of glazing (COG), calculated according to NFRC 2010 (which includes NFRC 100-2010) standard default settings. U factors, unless indicated to the contrary, are winter/night U factors. U factors, unless indicated to the contrary, are reported in units of BTU/(hr*ft²*° F.). SHGC values, unless indicated to the contrary, are summer/day values. Color values (e.g., L*, a*, b*) are in accordance with the 1976 CIELAB color system specified by the International Commission on Illumination. The L*, a*, b* values in the specification and claims represent color center point values.

### EXAMPLES

### Examples 1-3

Three IGU transparencies were prepared having the specific materials and target thicknesses shown in Table 1. Each coating was coated on a 6 mm clear glass substrate and with a second substrate also present and spaced 0.5 inches apart, the gap therebetween being filled with air.

TABLE 1
EXAMPLES 1-3

| | Coating Thickness |
|---|---|
| Coating material | (Angstroms) |
| Zn Stannate (first above substrate) | 217.3 |
| Zn Oxide | 71.5 |
| Ag | 176.9 |
| TiO₂ | 38.4 |
| Zn Oxide | 69.6 |
| Zn Stannate | 301.2 |
| Ag | 11 |
| TiO₂ | 15 |
| Zn Oxide | 10 |
| Zn Stannate | 360.4 |
| Zn Oxide | 74.7 |
| Ag | 160 |
| TiO₂ | 29 |
| Zn Oxide | 83.6 |
| Zn Stannate | 197 |
| TiO₂ | 45.8 |

After the three transparencies were prepared, each of Examples 1-3 underwent testing. The various properties tested and the corresponding results for each of Examples 1-3 are shown in Table 2.

TABLE 2

| | Exam- | Exam- | Exam- |
|---|---|---|---|
| | ple 1 | ple 2 | ple 3 |
| Visible Light Transmittance (%) | 46.8 | 46.4 | 47.8 |
| Visible Light Exterior Reflectance (%) | 25.6 | 25.7 | 25.1 |
| Visible Light Interior Reflectance (%) | 16.6 | 16.2 | 16.6 |
| Solar Transmittance (%) | 20.5 | 20.3 | 21.1 |
| Solar Exterior Reflectance (%) | 40.4 | 40.5 | 39.8 |
| Solar Interior Reflectance (%) | 36.5 | 36.4 | 36.4 |
| UV Transmittance (%) | 13.1 | 13.1 | 13.2 |
| Winter U-value (Btu/(h*ft²* ° F.)) | 0.287 | 0.287 | 0.290 |
| Winter U-value (W/(m²*K)) | 1.632 | 1.632 | 1.646 |
| Summer U-value (Btu/(h*ft2* ° F.)) | 0.268 | 0.268 | 0.271 |
| Summer U-value (W/(m2*K)) | 1.520 | 1.520 | 1.540 |
| Shading Coefficient | 0.285 | 0.283 | 0.294 |
| Solar Heat Gain Coefficient | 0.248 | 0.247 | 0.256 |
| Light-to-solar Gain | 1.89 | 1.88 | 1.87 |
| Transmitted aesthetic CIELAB L* | 74.14 | 73.92 | 74.76 |
| Transmitted aesthetic CIELAB a* | −4.73 | −4.84 | −4.40 |
| Transmitted aesthetic CIELAB b* | 1.25 | 0.90 | 1.49 |
| Exterior Reflective aesthetic CIELAB L* | 57.64 | 57.70 | 57.20 |
| Exterior Reflective aesthetic CIELAB a* | −1.34 | −1.09 | −0.96 |
| Exterior Reflective aesthetic CIELAB b* | −4.81 | −4.40 | −5.80 |
| Interior Reflective aesthetic CIELAB L* | 48.12 | 47.62 | 48.11 |
| Interior Reflective aesthetic CIELAB a* | −4.54 | −3.82 | −3.63 |
| Interior Reflective aesthetic CIELAB b* | −14.52 | −15.42 | −14.27 |

### Examples 4-8

Five IGU transparencies were prepared having the specific materials and target thicknesses shown in Table 3. Each coating was coated on a 6 mm clear glass substrate and with a second substrate also present and spaced 0.5 inches apart, the gap therebetween being filled with air.

TABLE 3
EXAMPLES 4-8

| | Coating Thickness |
|---|---|
| Coating material | (Angstroms) |
| Zn Stannate (first above substrate) | 217.3 |
| Zn Oxide | 71.5 |
| Ag | 176.9 |
| TiO₂ | 38.4 |
| Zn Oxide | 69.6 |
| Zn Stannate | 301.2 |
| Ag | 11 |
| TiO₂ | 15 |
| Zn Stannate | 370.4 |
| Zn Oxide | 74.7 |
| Ag | 160 |
| TiO₂ | 29 |
| Zn Oxide | 83.6 |
| Zn Stannate | 197 |
| TiO₂ | 45.8 |

After the five transparencies were prepared, each of Examples 4-8 underwent testing. The various properties tested and the corresponding results for each of Examples 4-8 are shown in Table 4.

TABLE 4

| | Example | Example | Example | Example | Example |
|---|---|---|---|---|---|
| | 4 | 5 | 6 | 7 | 8 |
| Visible Light Transmittance (%) | 48.0 | 46.3 | 46.4 | 46.6 | 47.1 |
| Visible Light Exterior Reflectance (%) | 24.2 | 25.4 | 26.4 | 26.4 | 24.6 |
| Visible Light Interior Reflectance (%) | 16.8 | 16.5 | 17.3 | 17.3 | 16.7 |
| Solar Transmittance (%) | 20.8 | 20.4 | 20.1 | 20.3 | 20.4 |
| Solar Exterior Reflectance (%) | 40.8 | 41.0 | 42.0 | 42.1 | 38.7 |
| Solar Interior Reflectance (%) | 36.4 | 36.0 | 36.8 | 36.8 | 36.6 |
| UV Transmittance (%) | 11.2 | 11.3 | 10.9 | 10.7 | 11.0 |
| Winter U-value (Btu/(h*ft²* ° F.)) | 0.289 | 0.288 | 0.287 | 0.288 | 0.290 |
| Winter U-value (W/(m²*K)) | 1.640 | 1.636 | 1.632 | 1.636 | 1.644 |
| Summer U-value (Btu/(h*ft2* ° F.)) | 0.270 | 0.269 | 0.268 | 0.269 | 0.271 |
| Summer U-value (W/(m2*K)) | 1.531 | 1.526 | 1.520 | 1.526 | 1.537 |
| Shading Coefficient | 0.289 | 0.284 | 0.280 | 0.281 | 0.286 |
| Solar Heat Gain Coefficient | 0.251 | 0.247 | 0.243 | 0.245 | 0.249 |
| Light-to-solar Gain | 1.91 | 1.88 | 1.91 | 1.90 | 1.89 |
| Transmitted aesthetic CIELAB L* | 74.85 | 73.83 | 73.86 | 74.00 | 74.30 |
| Transmitted aesthetic CIELAB a* | −4.80 | −5.10 | −4.95 | −4.79 | −4.38 |
| Transmitted aesthetic CIELAB b* | 2.97 | 1.35 | 2.05 | 2.30 | 1.98 |
| Exterior Reflective aesthetic CIELAB L* | 56.39 | 57.46 | 58.41 | 58.42 | 56.74 |
| Exterior Reflective aesthetic CIELAB a* | −2.04 | −0.89 | −1.38 | −0.82 | −1.75 |
| Exterior Reflective aesthetic CIELAB b* | −6.19 | −4.44 | −5.83 | −6.34 | −5.36 |
| Interior Reflective aesthetic CIELAB L* | 48.35 | 47.99 | 49.01 | 49.09 | 48.26 |
| Interior Reflective aesthetic CIELAB a* | −5.84 | −4.24 | −5.29 | −4.65 | −5.33 |
| Interior Reflective aesthetic CIELAB b* | −13.19 | −14.84 | −14.79 | −14.98 | −12.70 |

The invention claimed is:

1. A coated article, comprising:
at least a first substrate having a first surface and a second surface opposite of the first surface; and
a coating over at least a portion of one of the surfaces of the first substrate, the coating comprising:
a first dielectric layer over at least a portion of the substrate;
a first metallic layer over at least a portion of the first dielectric layer;
a first primer layer over at least a portion of the first metallic layer;
a second dielectric layer over at least a portion of the first primer layer, the second dielectric layer comprising a zinc stannate film;
a second metallic layer over at least a portion of the second dielectric layer;
a second primer layer over at least a portion of the second metallic layer;
a third dielectric layer over at least a portion of the second primer layer;
a third metallic layer over at least a portion of the third dielectric layer;
a third primer layer over at least a portion of the third metallic layer;
a fourth dielectric layer over at least a portion of the third dielectric layer; and
a protective layer over at least a portion of the fourth dielectric layer;
wherein the second metallic layer is a discontinuous metallic layer having an effective thickness in the range of from 5 Å to 20 Å and which is formed directly over at least a portion of the zinc stannate film of the second dielectric layer; and
wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

2. The coated article of claim 1, wherein the substrate is a glass substrate.

3. The coated article of claim 1, wherein the first dielectric layer comprises: a first film comprising a zinc alloy oxide film; and a second film over at least a portion of the first film of the first dielectric layer, the second film comprising a zinc oxide film.

4. The coated article of claim 1, wherein the third dielectric layer comprises a first film comprising:
zinc oxide and having a thickness in the range of from 1 Å to 50 Å, or
zinc stannate.

5. The coated article of claim 4, wherein the third dielectric layer comprises: the first film comprising zinc oxide and having a thickness in the range of from 1 Å to 50 Å; and a second film over at least a portion of the first film of the third dielectric layer, the second film comprising an oxide of a zinc alloy.

6. The coated article of claim 5, wherein the third dielectric layer further comprises: a third film over at least a portion of the second film, the third film comprising zinc oxide.

7. The coated article of claim 4, wherein the third dielectric layer comprises: the first film comprising zinc stannate; and a second film over at least a portion of the first film of the third dielectric layer, the second film comprising zinc oxide.

8. The coated article of claim 7, wherein the first film of the third dielectric layer has a thickness in the range of from 250 Å to 450 Å.

9. The coated article of claim 1, wherein the first primer layer, the second primer layer, and the third primer layer each independently comprise titanium, zinc aluminum, nickel chromium, or a combination thereof.

10. The coated article of claim 1, further comprising a transmitted aesthetic CIELAB L*a*b* color value of L* in the range of from 72 to 80, a* in the range of from −5 to −2, and b* in the range of from −2 to 5 when the first substrate is a clear glass substrate.

11. The coated article of claim 1, wherein the coated article comprises exterior reflectance of between 10% and 50%

12. The coated article of claim 1, wherein the coated article is an insulating glass unit, and comprises a second substrate spaced apart from the first substrate.

13. The coated article of claim 12, further comprising an exterior reflective aesthetic CIELAB L*a*b* color value of L* in the range of from 55 to 60, a* in the range of from −3 to 0, and b* in the range of from −7 to −3; and an interior reflective aesthetic CIELAB L*a*b* color value of L* in the range of from 47 to 50, a* in the range of from −6 to −4, and b* in the range of from −16 to −12.

14. The coated article of claim 1, wherein the first metallic layer has a thickness in the range of from 125 Å to 225 Å.

15. The coated article of claim 1, wherein the third metallic layer has a thickness in the range of from 125 Å to 225 Å.

16. A method of forming a coated article comprising the steps of:
providing at least a first substrate having a first surface and a second surface opposite of the first surface; and
applying a coating over one of the surfaces of the first substrate, the applying the coating step comprising:
applying a first dielectric layer over at least a portion of the substrate;
applying a first metallic layer over at least a portion of the first dielectric layer;
applying a first primer layer over at least a portion of the first metallic layer;
applying a second dielectric layer over at least a portion of the first primer layer;
applying a second metallic layer over at least a portion of the second dielectric layer;
applying a second primer layer over at least a portion of the second metallic layer;
applying a third dielectric layer over at least a portion of the second primer layer;
applying a third metallic layer over at least a portion of the third dielectric layer;
applying a third primer layer over at least a portion of the third metallic layer;
applying a fourth dielectric layer over at least a portion of the third dielectric layer; and
applying a protective layer over at least a portion of the fourth dielectric layer;
wherein the applying the second dielectric layer step comprises applying a zinc stannate film;
wherein the second metallic layer is a discontinuous metallic layer having a thickness in the range of from 5 Å to 20 Å and which is formed directly over at least a portion of the zinc stannate film of the second dielectric layer; and
wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.

17. The method of claim 16, wherein the applying the first dielectric layer step comprises: applying a first film comprising a zinc alloy oxide film; and applying a second film over at least a portion of the first film of the first dielectric layer, the second film comprising a zinc oxide film.

18. The method of claim 16, wherein the applying a third dielectric layer step comprises applying a first film; wherein the first film comprises:
zinc oxide and having a thickness in the range of from 1 Å to 50 Å, or
zinc stannate.

19. The method of claim 16, wherein the coated article comprises a transmitted aesthetic CIELAB L*a*b* color value of L* in the range of from 72 to 80, a* in the range of from −5 to −2, and b* in the range of from −2 to 5 when the first substrate is a clear glass substrate.

20. A coated article, comprising:
at least a first substrate having a first surface and a second surface opposite of the first surface; and
a coating over at least a portion of one of the surfaces of the first substrate, the coating comprising:
a first dielectric layer over at least a portion of the substrate;
a first metallic layer over at least a portion of the first dielectric layer;
a first primer layer over at least a portion of the first metallic layer;
a second dielectric layer over at least a portion of the first primer layer, the second dielectric layer comprising a zinc stannate film;
a second metallic layer over at least a portion of the second dielectric layer;
a second primer layer over at least a portion of the second metallic layer;
a third dielectric layer over at least a portion of the second primer layer;
a third metallic layer over at least a portion of the third dielectric layer;
a third primer layer over at least a portion of the third metallic layer;
a fourth dielectric layer over at least a portion of the third dielectric layer; and
a protective layer over at least a portion of the fourth dielectric layer;
wherein the second metallic layer is a discontinuous metallic layer having an effective thickness in the range of from 5 Å to 20 Å and which is formed directly over at least a portion of the zinc stannate film of the second dielectric layer;
wherein the coated article comprises a visible light transmittance in the range of from 40% to 60%; and
wherein the coated article has a neutral transmitted aesthetic CIELAB L*a*b* color value comprising an a* of greater than −4 and a b* in the range of from −4 to 4 while maintaining a reflective aesthetic CIELAB L*a*b* color a* value of no less than −10.
